(19) United States
(12) Patent Application Publication
(10) Pub. No.: US 2007/0233724 A1
(43) Pub. Date: Oct. 4, 2007

(54) Computer-readable recording medium recorded with performance information collection program, and performance information collection apparatus and method

(75) Inventor: Minoru Kyoya, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 11/452,892

(22) Filed: Jun. 14, 2006

(30) Foreign Application Priority Data
Mar. 28, 2006 (JP) 2006-087599

(51) Int. Cl. G06F 7/00

(52) U.S. Cl. 707/102

(57) ABSTRACT

In a business system constructed by a web server, an AP server, and a DB server serially connected in this order, the times required for the transmission and reception of messages with respect to the servers or business applications located in downstream processes of the servers, are respectively measured. Then, performance information associated with, at the very least, these times is created for the identifier that identifies the business application, and this is transmitted to and collected in the administration server. The processing time spent in each server and business application, if under normal circumstances, is very small. Therefore if this deviates from a predetermined range, it can be easily identified that the business application thereof is being a bottleneck.

### BACKGROUND OF THE INVENTION

1. Field of the Invention

The present invention relates to technology that can identify business applications which become a bottleneck in business systems constructed by a web server, an AP (application) server, and a DB (database) server. More particularly, the present invention relates to a computer-readable recording medium recorded with performance information collection program, and performance information collection apparatus and method.

2. Description of the Related Art

In recent years, as business systems that perform banking activities and the like, IT systems constructed by a web server, an AP server, and a DB server serially connected in this sequence, are being utilized. In business systems, since the response closely relates to the quality of service, there is a need to identify the server that is the bottleneck. Consequently, in order to collect the performance information of business systems, technology in which response analysis and the like, is made possible by extracting the application logs of transactions from the transmission lines, has been proposed as disclosed in Japanese Unexamined Patent Publication No. 9(1997)-128342.

However, in the prior proposed technology, although it could be identified which amongst the web server, the AP server, and the DB server which construct the business system, is the bottleneck, it was not able to identify down to the business application that directly accesses the DB. As a result, even if it was identified that the DB server was the bottleneck, it could not be easily distinguished which of the plurality of business applications provided thereto was the cause, and there was a need for much time and effort in investigating the cause thereof.

Therefore, the present invention takes the problems of the prior technology as mentioned above into consideration, with an object of providing technology that can identify the business application which is the bottleneck, by creating performance information that is associated with the difference in the message transmission and reception times between the DB server and the business application, or between the AP server and the DB server, with respect to an identifier that identifies the business application.

### SUMMARY OF THE INVENTION

Therefore, in the performance information collection technology according to the present invention, in order to collect the performance information of a business system constructed by a web server, an application server and a database server serially connected in this order, and in which at least one business application that directly accesses the database is provided for the database server, when a message appended with an identifier that identifies the business application is received in the database server, a difference between a transmission time of a message to a business application identified by the identifier thereof, and a reception time of a response message from the business application thereof is calculated. Then, at the very least, performance information associated with the calculated difference is created with respect to the identifier, and this is transmitted to an administration server.

Furthermore, in order to collect the performance information of the business system, when a message containing business information to be processed in the business application is received in the application server, a difference between a transmission time of a message to the database server, and a reception time of a response message from the database server is calculated. Then, at the very least, performance information associated with the calculated difference is created with respect to the identifier that identifies the business application, and this is transmitted to an administration server.

According to the performance information collection technology of the present invention, in regard to the application server or the database server, the time required for the transmission and reception of messages with respect to the database servers or the business applications respectively located in the downstream processes thereof, is measured. Then, at the very least, the performance information associated with this measured time is created with respect to the identifier that identifies the business application, and this is transmitted to the administration server, and is collected. The processing time spent in the business application, if under normal circumstances, is very small. Therefore if this deviates from a predetermined range, it can be easily identified that the business application thereof is the bottleneck.

Other objects and aspects of this invention will become apparent inform the ensuing description of embodiments, in conjunction with the accompanying drawings.

### BRIEF DESCRIPTION OF THE DRAWINGS

FIG. 1 is an overall block diagram of a business system constructed by application of the present invention.

FIG. 2 is a flow chart showing performance information collection processing executed in a web server.

FIG. 3 is an explanatory drawing of a message transmitted from a terminal device to the web server.

FIG. 4 is an explanatory drawing of a message appended with a message identifier.

FIG. 5 is an explanatory drawing of performance information.

FIG. 6 is a flow chart showing performance information collection processing executed in an AP server.

FIG. 7 is an explanatory drawing of an administration table for identifying business application names.

FIG. 8 is an explanatory drawing of a message in which business information has been replaced with the business application name.

FIG. 9 is a flow chart showing performance information collection processing executed in a DB server.

FIG. 10 is a schematic explanatory drawing of performance information collection technology according to the present invention.

### DESCRIPTION OF THE PREFERRED EMBODIMENT

Hereunder, the present invention is explained in detail, with reference to the accomapnying drawings.

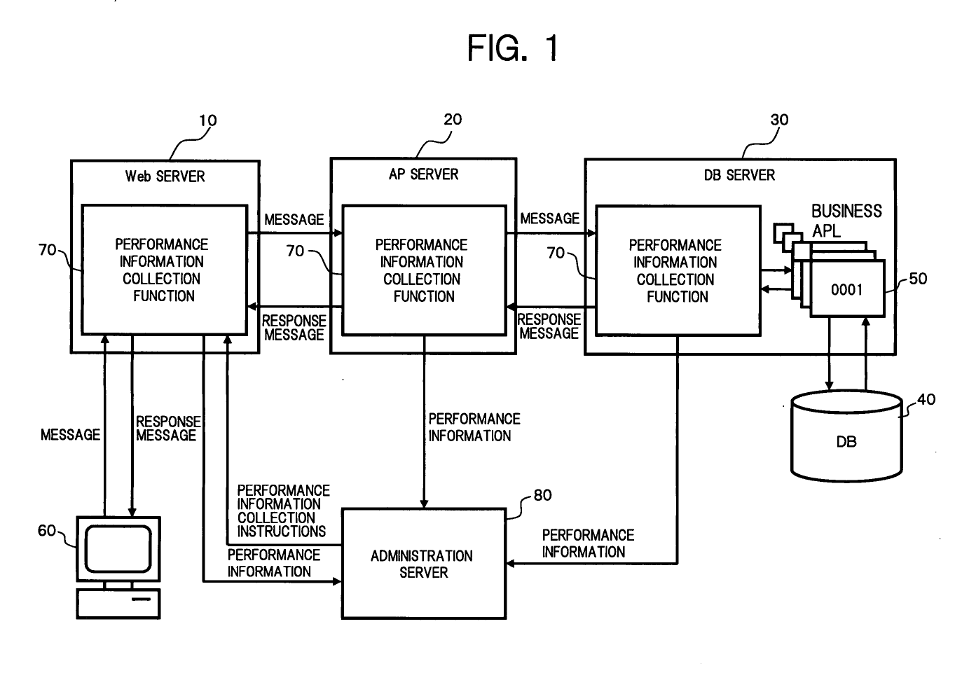

FIG. 1 represents a business system constructed by application of the present invention.

The business system is constructed with a web server 10, an AP server 20, and a DB server 30, which is comprised of a general purpose computer, serially connected in this order, and at least one business application 50 which directly accesses the DB 40, is provided for the DB server 30. The web server 10 is connected to a terminal device 60, such as a PC (Personal Computer) through a network, such as the Internet or an intranet, and accepts requests from users. The DB server 30 uses the business application 50 provided thereto, to access the DB 40 which stores data relating to various types of business. The AP server 20, in order to reduce the load of the web server 10, functions as middleware, which interfaces between user requests accepted by the web server 10, and DB access processing in the DB server 30.

Furthermore, in the web server 10, the AP server 20, and the DB server 30, by installing a performance information collection program recorded on a computer-readable recording medium such as a CD-ROM or a DVD-ROM, performance information collection functions 70 which collect the performance information of the business system, are respectively achieved. Then, in the web server 10, the AP server 20, and the DB server 30, the performance information respectively collected by the performance information collection functions 70 is transmitted to an administration server 80 which is comprised of a general purpose computer, through a network such as a dedicated line. In the administration server 80, in order to instruct whether or not performance information should be collected, it is configured such that it can transmit performance information collection instructions to the web server 10.

Here, the performance information collection functions 70 respectively realize, a step for calculating a difference, a step for creating performance information, a step for transmitting the performance information, a step for appending an identifier to a message, difference calculation means, performance information creation means, and performance information transmission means.

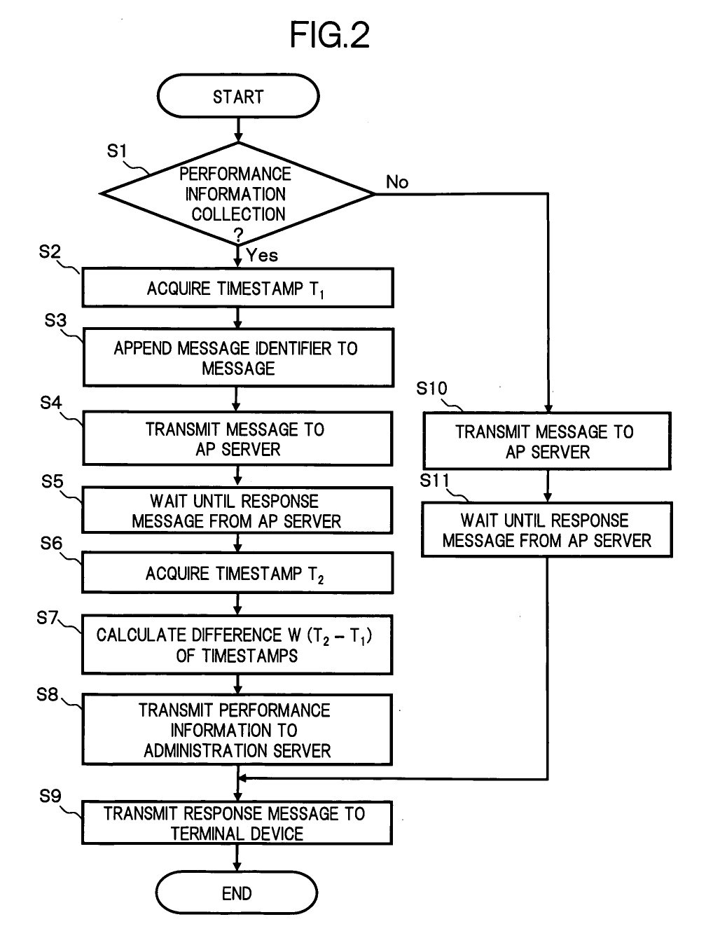

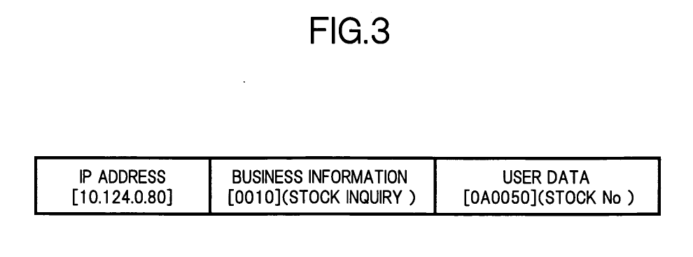

FIG. 2 shows performance information collection processing which is executed when a message containing, as shown in FIG. 3, an IP address for identifying the web server 10, business information, and user data, is received in the web server 10. Here, “business information” represents the contents that should be processed in the business system. For example, in the case of inventory control it is concepts containing; stock inquiries, orders, cancellations, and the like.

In step 1 (abbreviated as “S1” in the drawing, and the same hereunder), depending on the presence of a performance information collection instruction from the administration server 80, it is determined whether or not performance information is to be collected. Then, if performance information is to be collected, control proceeds to step 2 (Yes). On the other hand, if performance information is not to be collected, control proceeds to step 10 (No), and following transmission of the received message to the AP server 20 as is, control stands by in step 11 until a response message is returned from the AP server 20.

In step 2, for example, by utilizing the clock function of the general purpose computer that configures the web server 10, a timestamp T₁ immediately before transmission of the message to the AP server 20 is acquired.

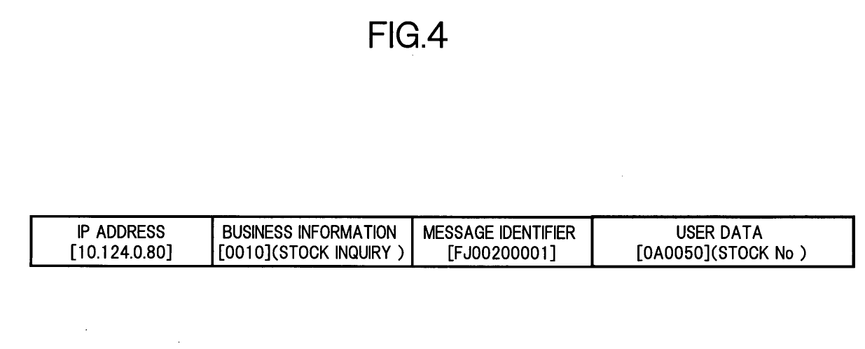

In step 3, a unique message identifier is assigned to the message, and, as shown in FIG. 4, the message identifier thereof is set (added) to the vendor dedicted area of the message. Here, the reason for setting the message identifier is that since multiple messages are processed in the business system, then as mentioned below, when measuring the time required for the transmission and reception of the message, there is a need to identify the message thereof.

In step 4, the message in which the message identifier has been set, is transmitted to the AP server 20.

In step 5, control stands by until a response message is returned from the AP server 20.

In step 6, a timestamp T₂ of the time of reception of the response message, is acquired using the same method as step 2.

In step 7, in order to measure the time required from the transmission of the message to the AP server 20 until the reception of the response message from the AP server 20, a difference W (T₂−T₁) of the timestamps is calculated.

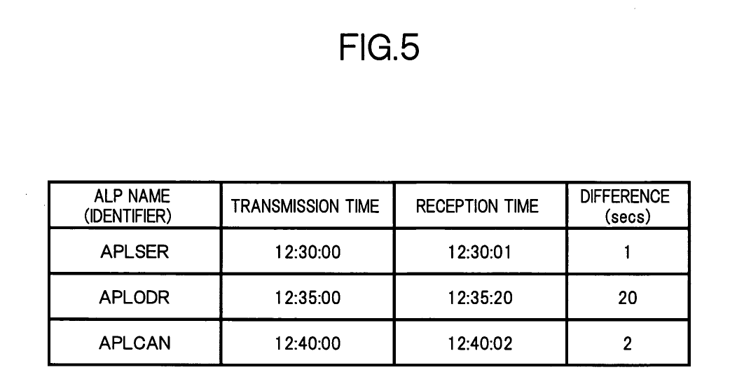

In step 8, as shown in FIG. 5, performance information associated with the timestamp T₁ which represents the transmission time, the timestamp T₂ which represents the reception time, and the difference W, is created for the identifier that identifies the business application 50, and this is transmitted to the administration server 80. Here, the identifier for identifying the business application 50, as mentioned below, uses one that has been added to the message by the performance information collection processing in the AP server 20. As performance information, it is acceptable, if at the very least, the difference W of the timestamps are associated with the identifier that identifies the business application 50 (and the same hereunder).

In step 9, the response message is transmitted to the terminal device 60.

According to such performance information collection processing, in the web server 10, if the performance information is to be collected, a message identifier is added to the message, and the difference W of the timestamps at the time of transmission and reception of the message with respect to the AP server 20 is calculated. Then, performance information associated with the timestamp T₁, the timestamp T₂, and the difference W thereof is created for the identifier of the business application 50 which is identified by the business information, and this is transmitted to the administration server 80.

Consequently, in the administration server 80, by referring to the performance information transmitted from the web server 10, the business application 50 that is the bottleneck can be identified very easily. For example, in the performance information shown in FIG. 5, it can be understood at a glance that the business application 50 identified by APLODR has a longer processing time than the other applications. Accordingly, by reviewing the business application 50 thereof, the response of the business system can be improved.

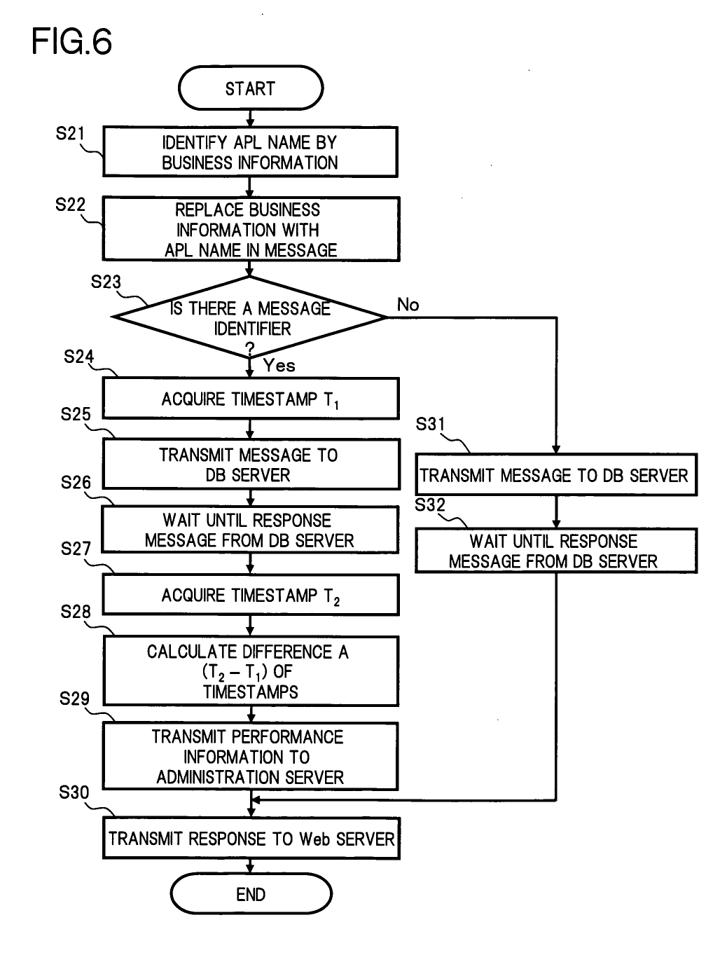

FIG. 6 shows performance information collection processing executed in the AP server 20, at the time of reception of the message shown in FIG. 4 from the web server 10.

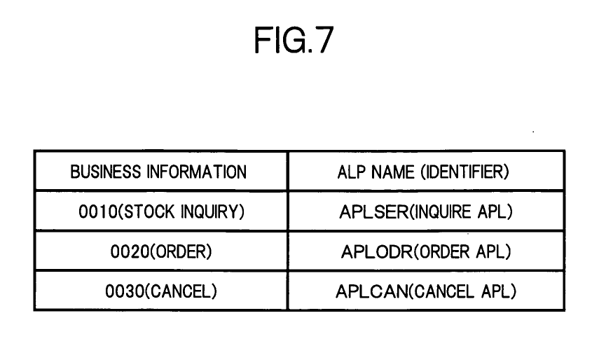

In step 21, the business application (APL) name is identified by the business information added to the message, by referring to the administration table shown in FIG. 7. Here, the administration table is one that associates the business information and the business application 50 that performs the business thereof, and is created prior to the operation of the business system.

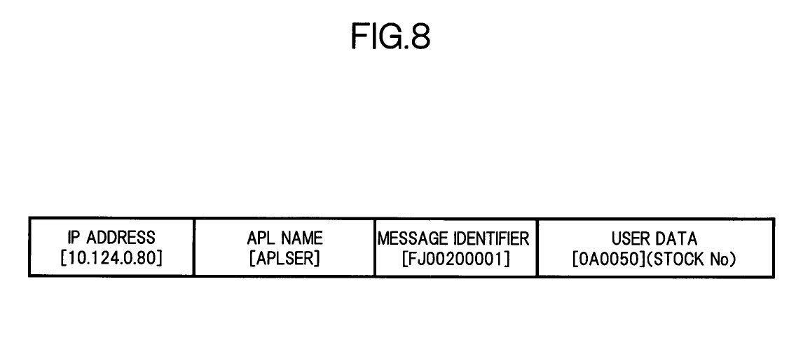

In step 22, as shown in FIG. 8, the business information added to the message is replaced with the business application name.

In step 23, it is determined whether or not a message identifier has been added to the message. That is to say, if a message identifier has been added to the message in the web server 10, it can be determined that there has been a performance information collection instruction from the administration server 80. Therefore, it is determined whether or not performance information should be collected according to the presence of the message identifier. Then, if a message identifier has been added to the message, control proceeds to step 24 (Yes). On the other hand, if a message identifier has not been added to the message, control proceeds to step 31 (No), and following transmission of the message to the DB server 30, control stands by in step 32 until a response message is returned from the DB server 30.

In step 24, a timestamp T₁ immediately before the transmission of the message to the DB server 30 is acquired.

In step 25, the message is transmitted to the DB server 30.

In step 26, control stands by until a response message is returned from the DB server 30.

In step 27, a timestamp T₂ of the time of the reception of the response message is acquired.

In step 28, in order to measure the time required from the transmission of the message to the DB server 30 until the reception of the response message from the DB server 30, a difference A (T₂−T₁) of the timestamps is calculated.

In step 29, as shown in FIG. 5, performance information associated with the timestamp T₁ which represents the transmission time, the timestamp T₂ which represents the reception time, and the difference A, is created for the identifier that identifies the business application 50, and this is transmitted to the administration server 80.

In step 30, the response message is transmitted to the web server 10.

According to such performance information collection processing, in the AP server 20, the business application name is identified by the business information added to the message, and the business information is replaced with the business application name. Furthermore, according to whether or not a message identifier has been added to the message, it is determined whether or not performance information should be collected. Then, if performance information is to be collected, performance information associated with the timestamp T₁, the timestamp T₂, and the difference A is created for the identifier of the business application 50 in the same manner as the performance information collection processing in the web server 10, and this is transmitted to the administration server 80.

In the administration server 80, the effect of identifying the business application 50 that is the bottleneck by referring to the performance information, and thus being able to improve the response of the business system, has been previously explained for the performance information collection processing in the web server 10, and hence the explanation is omitted here (and the same hereunder).

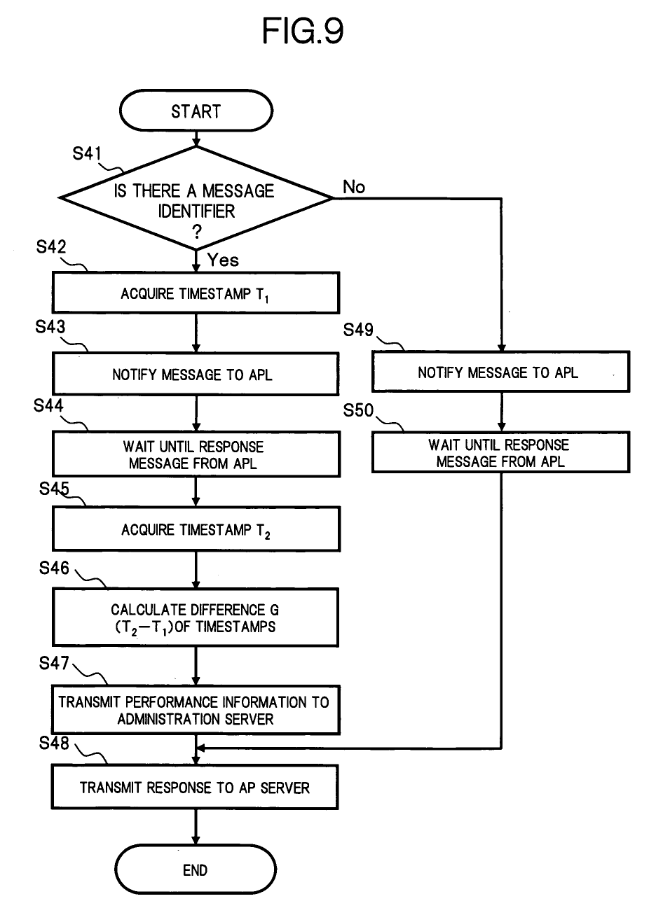

FIG. 9 shows performance information collection processing executed in the DB server 30 when the message shown in FIG. 8 is received from the AP server 20.

In step 41, it is determined whether or not a message identifier has been added to the message. Then, if a message identifier has been added to the message, control proceeds to step 42 (Yes). On the other hand, if a message identifier has not been added to the message, control proceeds to step 49 (No), and following notification (transmission) of the message to the business application 50 that is identified by the business application name, control stands by in step 50 until a response message is returned from the business application 50 thereof.

In step 42, a timestamp T₁ immediately before notifying the message to the business application 50 is acquired.

In step 43, the message is notified (transmitted) to the business application 50 that is identified by the business application name.

In step 44, control stands by until a response message is returned from the business application 50.

In step 45, a timestamp T₂ of the time of reception of the response message is acquired.

In step 46, in order to measure the time required from the notification of the message to the business application 50 until the reception of the response message from the business application 50, a difference G (T₂−T₁) of the timestamps is calculated.

In step 47, as shown in FIG. 5, performance information associated with the timestamp T₁ which represents the transmission time, the timestamp T₂ which represents the reception time, and the difference G is created for the identifier that identifies the business application 50, and this is transmitted to the administration server 80.

In step 48, the response message is transmitted to the AP server 20.

According to such performance information collection processing, in the DB server 30, depending on whether or not a message identifier has been added to the message, it is determined whether or not performance information should be collected. Then, if performance information is to be collected, performance information associated with the timestamp T₁, the timestamp T₂, and the difference G is created for the identifier of the business application 50 in the same manner as the performance information collection processing in the web server 10, and this is transmitted to the administration server 80.

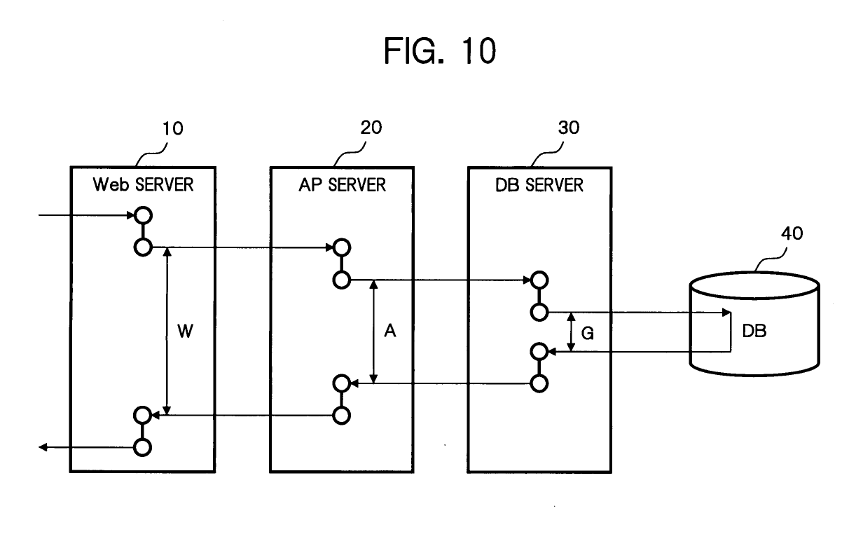

Accordingly, in the performance information collection technology according to the present invention, as shown in FIG. 10, in the web server 10, the AP server 20, and the DB server 30, the times W, A and G, required for the transmission and reception of messages with respect to the servers or business applications located in downstream processes thereof, are respectively measured. Then, performance information associated with, at the very least, these times W, A, and G, is created for the identifier that identifies the business application 50, and this is collected in the administration server 80. Here, the processing time spent in each server and business application, if under normal circumstances, is very small. Therefore if this deviates from a predetermined range, it can be easily identified that the business application thereof is being a bottleneck.

In order to collect the performance information of the business system, it is acceptable if, at the very least, the performance information collection function 70 is provided to the AP server 20, or the DB server 30.

I claim:

1. A computer-readable recording medium recorded therein with a performance information collection program for collecting performance information of a business system constructed by a web server, an application server, and a database server serially connected in this order, and in which at least one business application that directly accesses the database is provided for the database server, and which is installed on said database server, said program being for realizing:
a step for, when a message appended with an identifier that identifies said business application is received, calculating a difference between a transmission time of a message to a business application identified by said identifier, and a reception time of a response message from the business application;
a step for, at the very least, creating performance information associated with the calculated difference with respect to said identifier, and
a step for transmitting the created performance information to an administration server.

2. The computer-readable recording medium recorded therein with a performance information collection program according to claim 1, wherein said step for calculating a difference, calculates a difference based on a timestamp immediately before transmission of said message to a business application, and a timestamp of the time of reception of the response message from said business application.

3. The computer-readable recording medium recorded therein with a performance information collection program according to claim 1, wherein said step for calculating a difference, calculates a difference only when a message is appended with a message identifier.

4. A computer-readable recording medium recorded therein with a performance information collection program for collecting performance information of a business system constructed by a web server, an application server, and a database server serially connected in this order, and in which at least one business application that directly accesses the database is provided for the database server, and which is installed on said application server, said program being for realizing:
a step for, when a message containing business information to be processed in said business application is received, calculating a difference between a transmission time of a message to said database server, and a reception time of a response message from the database server;
a step for, at the very least, creating performance information associated with the calculated difference, with respect to an identifier that identifies said business application; and
a step for transmitting the created performance information to an administration server.

5. A computer-readable recording medium recorded therein with a performance information collection program according to claim 4, for further realizing a step for, when said message is received, referring to a table in which business information and business applications are associated, and identifying a business application corresponding to business information containing said message, and appending said identifier to the message.

6. A computer-readable recording medium recorded therein with a performance information collection program according to claim 4, wherein said step for calculating a difference, calculates a difference based on a timestamp immediately before transmission of said message to a database server, and a timestamp of the time of reception of the response message from said database server.

7. The computer-readable recording medium recorded therein with a performance information collection program according to claim 4, wherein said step for calculating a difference, calculates a difference only when a message is appended with a message identifier.

8. A performance information collection apparatus for collecting performance information of a business system constructed by a web server, an application server, and a database server serially connected in this order, and in which at least one business application is provided for the database server for directly accessing the database, the apparatus being provided for the database server and comprising:
difference calculating means configured to, when a message appended with an identifier that identifies said business application is received, calculate a difference between a transmission time of a message to a business application identified by said identifier, and a reception time of a response message from the business application;
performance information creating means configured to, at the very least, create performance information associated with the difference calculated by said difference calculating means, with respect to said identifier, and
performance information transmitting means configured to transmit the performance information created by said performance information creating means, to an administration server.

9. A performance information collection apparatus for collecting performance information of a business system constructed by a web server, an application server, and a database server serially connected in this order, and in which at least one business application is provided for the database server for directly accessing the database, the apparatus being provided for the application server and comprising:
difference calculating means configured to, when a message containing business information to be processed in said business application is received, calculate a difference between a transmission time of a message to said database server, and a reception time of a response message from the database server;
performance information creating means configured to, at the very least, create performance information associated with the difference calculated by said difference calculating means, with respect to an identifier that identifies said business application; and
performance information transmitting means configured to transmit the performance information created by said performance information creating means, to an administration server.

10. A performance information collection method for collecting performance information of a business system constructed by a web server, an application server, and a database server serially connected in this order, and in which at least one business application that directly accesses the database is provided for the database server, said method permitting the database server to execute the steps of:
calculating, when a message appended with an identifier that identifies said business application is received, a difference between a transmission time of a message to a business application identified by said identifier, and a reception time of a response message from the business application;
creating, at the very least, performance information associated with the calculated difference with respect to said identifier, and
transmitting the created performance information to an administration server.

11. A performance information collection method for collecting performance information of a business system constructed by a web server, an application server, and a database server serially connected in this order, and in which at least one business application that directly accesses the database is provided for the database server, said method permitting the application server to execute the steps of:
calculating, when a message containing business information to be processed in said business application is received, a difference between a transmission time of a message to said database server, and a reception time of a response message from the database server;
creating, at the very least, performance information associated with the calculated difference, with respect to an identifier that identifies said business application; and
transmitting the created performance information to an administration server.
